(19) United States
(12) Patent Application Publication
(10) Pub. No.: US 2007/0083523 A1
(43) Pub. Date: Apr. 12, 2007

(54) Procurement information access via electronic mail

(75) Inventors: Michael Gerard, Durango, CO (US); Byron O'Dell, Highlands Ranch, CO (US)

Correspondence Address: THE OLLILA LAW GROUP LLC, 2060 BROADWAY, SUITE 300, BOULDER, CO, 80302, US

(73) Assignee: IMI Norgren, Inc.

(21) Appl. No.: 11/248,353

(22) Filed: Oct. 12, 2005

(51) Int. Cl. G06F 17/30

(52) U.S. Cl. 707/10

(57) ABSTRACT

A procurement information system is provided. The system includes an electronic mail interface configured to receive an information request over a communication link, and to transfer over the communication link retrieved information relating to the information request. Also provided is a processor configured to process the information request to determine the retrieved information, and to retrieve the retrieved information from a database. The information request includes a price quote request for a first item unavailable for shipment at the time the information request is received. The retrieved information includes a price quote for a second item available for shipment at the time the information request is received.

### FIELD OF THE INVENTION

Aspects of the invention relate generally to the procurement of parts, subassemblies, completed products, and the like, and more particularly to procurement information access by way of electronic mail.

### BACKGROUND OF THE INVENTION

An important aspect of conducting business in the manufacturing sector is the procurement of components, subassemblies, and other products required for the assembly of saleable products, such as electronic systems, mechanical devices, industrial equipment, and myriad other objects of commerce. In addition, the purchase of completed products by retailers, distributors, and the like constitute another important segment of the economy.

Oftentimes, a purchaser obtains information from one or more suppliers regarding a type of product or item available for purchase. Typically, the purchaser thereafter requests quotes from one or more of the suppliers of these products. The request normally includes an identification of the type of product desired, and may also contain a quantity of product and a desired delivery date. Each of the suppliers interested in conducting business with the purchaser then provides the purchaser a quote listing the price of the requested products, possibly with an anticipated delivery date and other terms of the proposed sale. Based on this information, the purchaser selects a supplier based on the received quotes. The purchaser then orders the products from the selected supplier. In response, the supplier delivers the products, which may need to be manufactured in response to the order if a sufficient quantity of the product is not already being held in the supplier's stock. During this time, the purchaser and the supplier typically communicate periodically regarding the status of the order. Also, the purchaser pays for the goods at a time agreed upon by both parties.

As may be evident from the foregoing discussion, the transfer of information between the purchase and the potential suppliers is a critical portion of the procurement process. Historically, this information transfer has occurred by way of telephonic or standard mail communication between the purchaser and a customer service representative of the supplier. Later, facsimile and e-mail transmissions allowed faster communications between personnel involved with the transaction, albeit with the continued involvement of the representative of the supplier. More recently, the World Wide Web has allowed the purchaser to access a web page provided by the supplier to obtain information about products, and to track the status of a previously placed order. While this most recent method of communication typically requires less direct involvement from employees of the supplier, the web interface provided for that purpose is often difficult to locate among other web pages provided by the supplier. Also, when this web interface is inaccessible from time to time, the purchaser must wait until the interface is once again available before submitting a request for procurement information.

### SUMMARY OF THE INVENTION

One embodiment of the present invention provides a procurement information system that includes an electronic mail interface configured to receive an information request over a communication link, and to transfer over the communication link retrieved information relating to the information request. A processor is also included that is configured to process the information request to determine the retrieved information, and to retrieve the retrieved information from a database. The information request includes a price quote request for a first item unavailable for shipment at the time the information request is received. The retrieved information includes a price quote for a second item available for shipment at the time the information request is received.

In another embodiment of the invention, a method for providing procurement information is provided. A first electronic mail message comprising an information request is received over a communication link. The information request is processed to determine information retrieved from a database. A second electronic mail message comprising the retrieved information is transferred over the communication link. The information request comprises a price quote request for a first item unavailable for shipment when the information request is received. Further, the retrieved information comprises a price quote for a second item available for shipment when the information request is received.

Additional embodiments and advantages of the present invention will be realized by those skilled in the art upon perusal of the following detailed description, taken in conjunction with the accompanying drawings.

### BRIEF DESCRIPTION OF THE DRAWINGS

FIG. 1 is a block diagram of a procurement information system according to an embodiment of the invention.

FIG. 2 is a flow diagram of a method of providing procurement information according to an embodiment of the invention.

FIG. 3 is a block diagram of a procurement information system according to another embodiment of the invention.

FIG. 4A is a flow diagram of a method of providing procurement information according to another embodiment of the invention.

FIG. 4B is a flow diagram of processing a product information request according to the method of FIG. 4A.

FIG. 4C is a flow diagram of processing a price quote request according to the method of FIG. 4A.

FIG. 4D is a flow diagram of processing a purchase order according to the method of FIG. 4A.

FIG. 4E is a flow diagram of processing a purchase order status request according to the method of FIG. 4A.

### DETAILED DESCRIPTION OF THE INVENTION

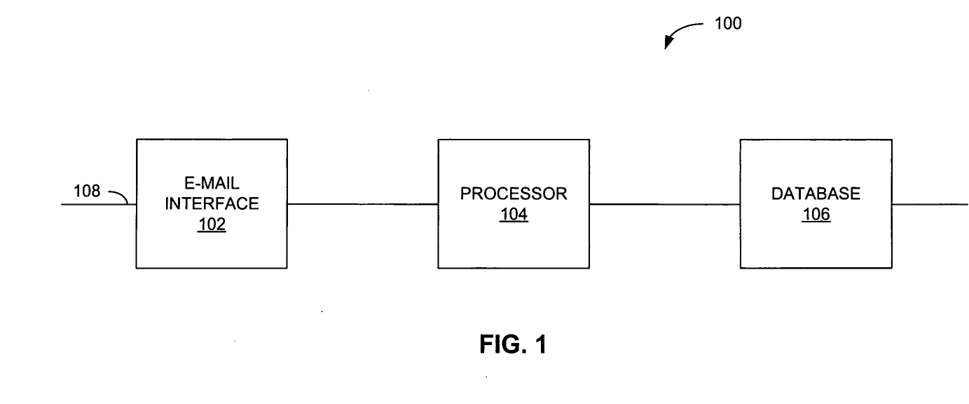

FIG. 1 is a block diagram of a procurement information system 100 according to one embodiment of the invention. The system 100 includes an electronic mail (e-mail) interface 102, a processor 104, and a database 106. The e-mail interface 102 is configured to receive an information request over a communication link 108. In addition, the e-mail interface 102 is configured to transfer retrieved information relating to the information request over the communication link 108. The processor 104 is configured to process the information request to determine the retrieved information. The processor 104 is further configured to access the database 106 to retrieve the retrieved information. In one embodiment, the information request includes a request for a price quote for a first item that is unavailable for shipment at the time the request is received. The retrieved information comprises a price quote for a second item that is available for shipment at the time the request is received.

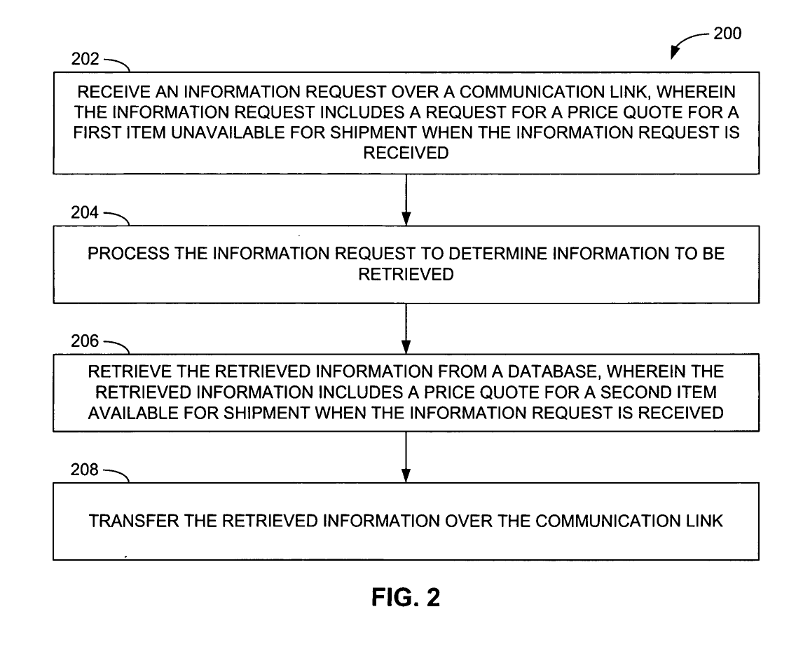

FIG. 2 provides a flow diagram of a method 200 of providing procurement information according to another embodiment of the invention. An information request is received over a communication link (operation 202). The information request is processed to determine information to be retrieved (operation 204). The retrieved information is retrieved from a database (operation 206). The retrieved information is transferred over the communication link (operation 208). In this embodiment, the information request includes a request for a price quote for a first item unavailable for shipment at the time the request is received. Also, the retrieved information comprises a price quote for a second item available for shipment at the time the request is received.

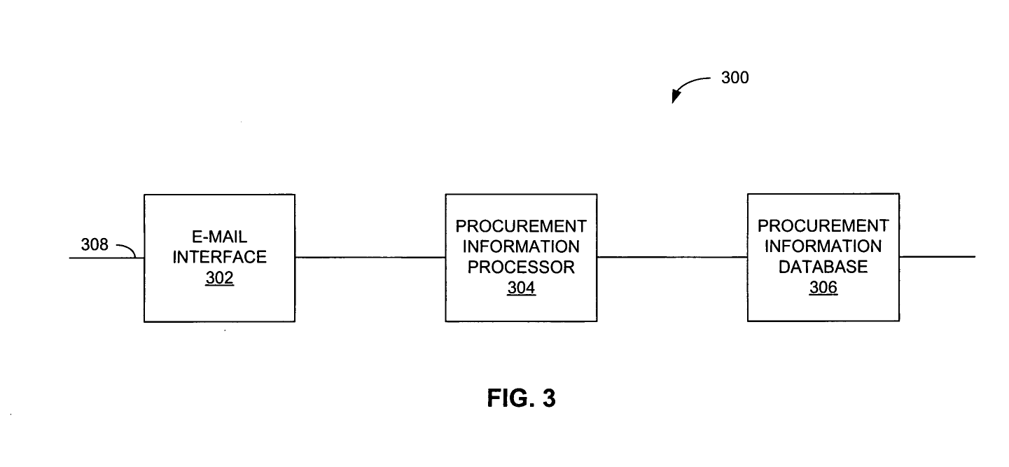

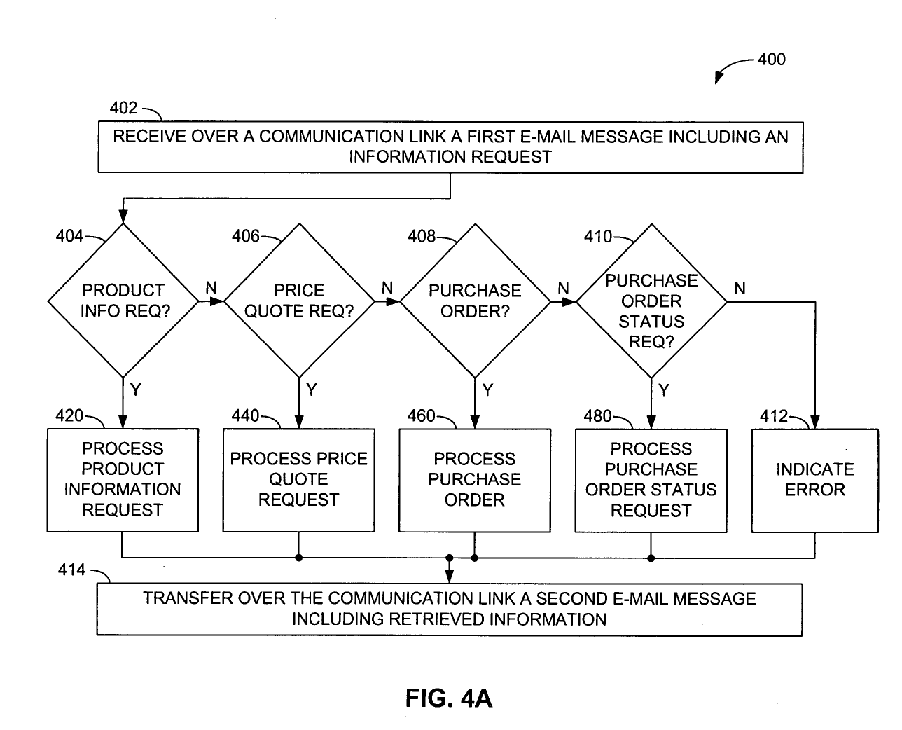

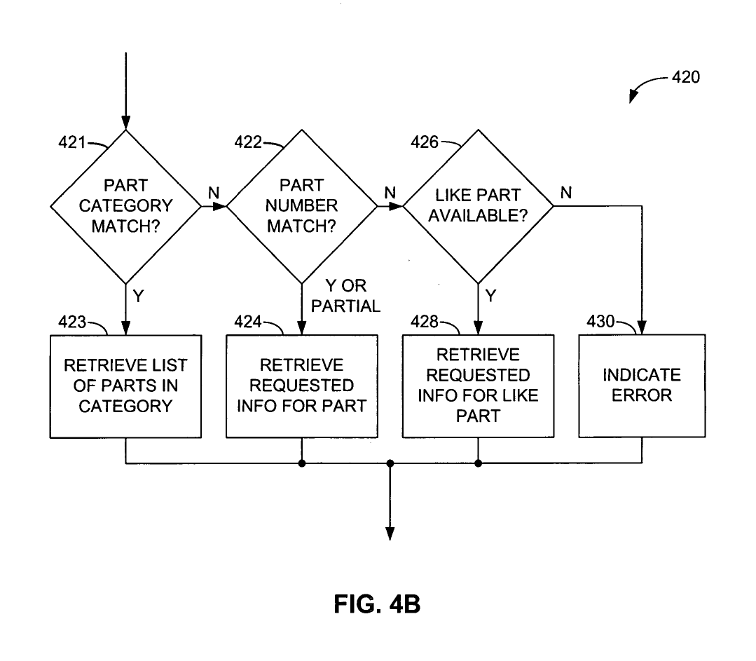

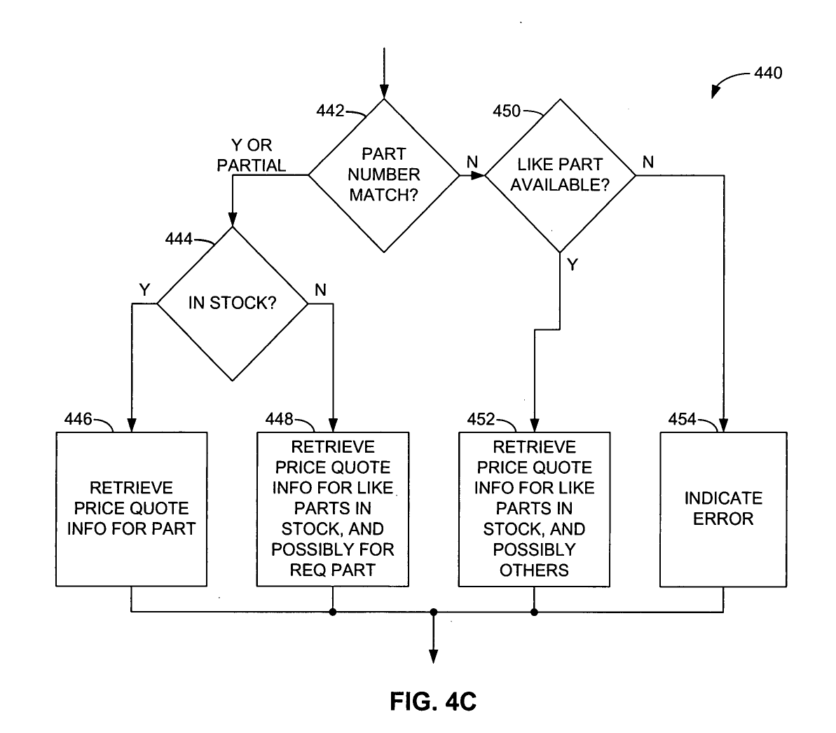

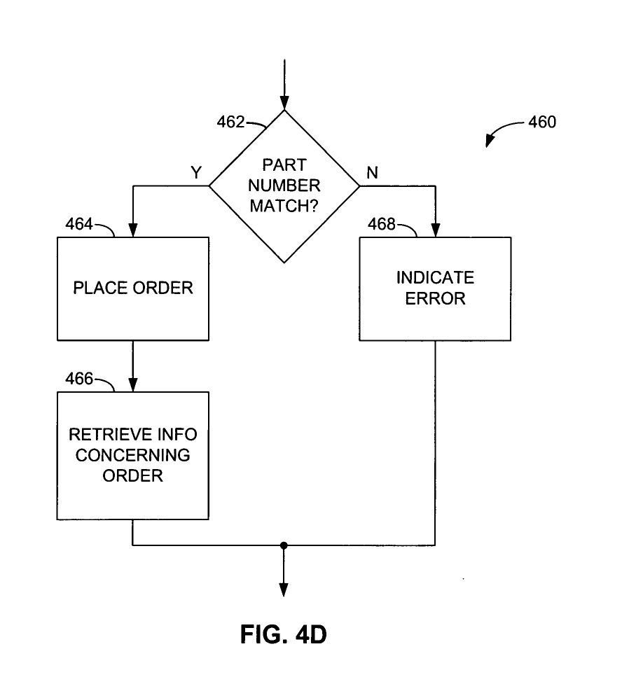

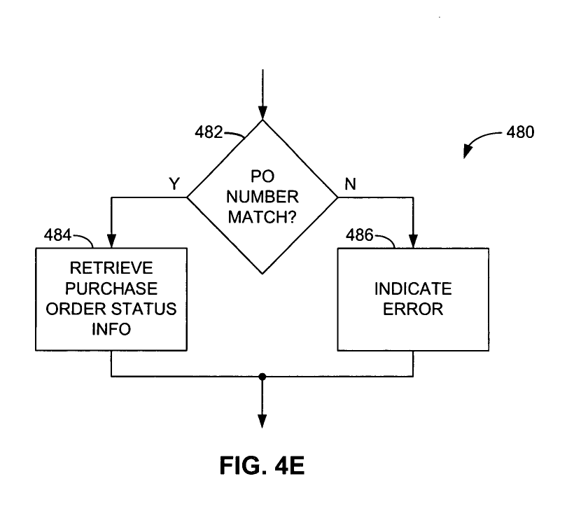

FIG. 3 presents a procurement information system 300 employable by a supplier in a particular embodiment of the invention. In conjunction with FIG. 3, a flow diagram presented in FIGS. 4A through 4E describes a method 400 of providing procurement information undertaken by the procurement information system 300. The system 300 includes an e-mail interface 302, a procurement information processor 304, and a procurement information database 306. The e-mail interface 302 is coupled with a communication link 308, and the procurement information processor 304 is coupled with both the e-mail interface 302 and the procurement information database 306. In one embodiment, the communication link 308 may be any communication link, such as a wireline or wireless link of a communication network, capable of carrying e-mail messages to and from the e-mail interface 302.

The e-mail interface 302 is configured to receive a procurement information request by way of a first electronic message over the communication link 308 from a user (not shown), such as an employee of a purchaser (operation 402). The procurement processor 304 is configured to process the procurement information request to determine procurement information to be retrieved, and then retrieve the procurement information from the procurement information database 306 (operations 404-410, 420, 440, 460, 480). If the type of requested information cannot be determined, the retrieved procurement information may take the form of an error message indicating the nature of the error (operation 412). The e-mail interface 302 is then further configured to transfer the retrieved procurement information over the communication link 308 by way of a second electronic message (operation 414).

The e-mail interface 302 may be capable of sending and receiving e-mail messages carrying the procurement information request and the retrieved procurement information in a variety of formats, including, but not limited to, plain-text format, rich-text format (RTF) and HyperText Markup Language (HTML). In one embodiment, the particular message format utilized may be determined by the user accessing the procurement information system 300. For example, a purchaser using a desktop or laptop computer may desire the retrieved procurement information to be in an easy-to-read HTML format, while another purchaser utilizing a personal digital assistant (PDA) may desire a plain-text format, given the typical screen size constraints imposed by a PDA.

In one implementation, the procurement information request is presented in the subject line of an e-mail message received by the e-mail interface 302. In other embodiments, the information request may reside within the body of the message, or in a separate file attached to the message. The retrieved procurement information transferred by the e-mail interface 302 may also reside within the subject line or body of the associated e-mail message, or may be attached as a file. Depending on the particular implementation, the information provided in a procurement information request may or may not be case sensitive, depending on the nature of the information, such as part numbers, provided in the request.

The retrieved procurement information may be any information or action relating to the potential or actual procurement of a saleable item. Such information may include, but is not limited to, product information, price information, quote information, availability information, purchase order information, and so forth. The database 306 may be any memory unit and associated software configured to store the retrieved procurement information in any of a plethora of data formats. In one embodiment, access to the database 306 may be implemented by way of the Structured Query Language (SQL) widely employed in conjunction with numerous databases.

The procurement information request may involve a request for any of a variety of information or actions involving the potential or actual procurement of an item available for purchase from the supplier. In one embodiment, the procurement information request may be a request for product information for a particular item or group of items sold by the supplier (operations 404 and 420 of FIG. 4A, and FIG. 4B). In one example, the request for product information may be a request for one or more item or part numbers belonging to a particular part category or description (operation 421). For example, a list of all part numbers associated with electronic amplifiers available from the supplier might be requested. In one implementation, this request may be indicated by the word “amplifiers” in the subject line of the e-mail embodying the request. In response, a list of the part numbers of all amplifiers available for purchase may be retrieved (operation 423). In another example, the request may include the keyword “overstock” or “obsolete” to obtain a list of all overstocked or obsolete parts available.

In another example, the request for product information may be a request for specific product information for a specific part or item. The item may be identified by way of a part number or stock-keeping unit (SKU) number, for example (operation 422). The requested product information may include, but is not limited to, photographs, computer-aided design (CAD) information, data sheets and product reviews relating to the product. For example, CAD information could include two-dimensional CAD drawings, three-dimensional CAD models, and other CAD-related information. In response, the procurement information processor 304 retrieves the requested product information from the procurement information database 306 (operation 424). In one embodiment, more than one form of product information may be requested and retrieved. Also, in some cases, if the identification of the item provided in the request does not match any item available from the supplier (operation 426), the supplier may return information for another item that may serve as a substitute for the item identified in the request (operation 428). In some embodiments, a substitute part, or “like” part, may not be a part that provides identical functionality or structure as the requested part. Also, the like part may be an overstocked or obsolete part. In one implementation, the procurement information processor 304 may be configured to correctly recognize a partial part number or item identification within the procurement information request in order to provide the retrieved product information corresponding to the correct item (operation 422). Otherwise, an error condition indicating an unsuccessful part number match may be returned as the retrieved information, possibly including some “help” text to guide the user regarding the nature of the error (operation 430). In another embodiment, information for more than one item may be requested within a single request in some embodiments, possibly by way of separating each item provided in the subject line of the e-mail message with commas, semicolons, or the like.

In another example, the procurement information request may be a price quote for a specific item (operations 406 and 440 of FIG. 4A, and FIG. 4C). The information included in the price quote request may be, for example, an identification of the desired item, a quantity of the item, and a delivery date (operation 442). In return, the procurement information processor 304 may retrieve information, at least some of which constitutes a price quote for the item indicated in the request (operation 446). For example, the retrieved procurement information may include, but is not limited to, the part number, a brief description of the part, a list price for the item, a net price for the item including any volume discount or other applicable discount, a quantity of the item currently in stock, a lead time for the requested quantity of parts, and a date and time stamp for the quote. Also, an expiration date after which the price quote ceases to be valid may also be included.

At times, a part number provided in the request refers to a part that is not currently in the supplier's stock for immediate or near-term shipment (operation 444). Under that scenario, the procurement information processor 304 may provide identification and price quote information for one or more parts currently in stock that may serve as a substitute for the part identified in the request (operation 448). In one implementation, the like or substitute part may be an obsolete or overstocked part available at a reduced price. In addition, price quote information for the originally requested part may be provided as well.

Under another scenario, a price quote may be requested using a part number that is not a valid part number for the supplier receiving the request (operation 450). In one embodiment, the procurement information processor 304 may retrieve from the procurement information database 306 price quote information for one or more parts in stock that may serve as substitutes for the part indicated in the price quote request (operation 452). In addition, price quote information for other potential substitute parts not currently in stock, but available from the supplier, may be retrieved and transferred over the communication link 308 as well. If a substitute part cannot be determined, an error indication may be returned (operation 454).

In a further embodiment, the procurement information processor 304 may be configured to correctly recognize a partial part number within the procurement information request in order to provide a price quote corresponding to the correct item, in a fashion similar to the product information request discussed (operation 442). Also, price quote information for more than one item may be requested within a single request in some embodiments, such as by way of separating each requested item with commas, semicolons, or other text delimiters.

In another example, the procurement information request may be a purchase order for a specific part or number of parts (operations 408, 460 of FIG. 4A, and FIG. 4D). In one implementation, the purchase order may include, without limitation, a part number and a quantity. In addition, the purchase order may refer to a previous price quote received by the purchaser from the supplier over the communication link 308. In one embodiment, the procurement information processor 304 checks to ensure the requested part number is one available from the supplier (operation 462). If so, the supplier may place the purchase order within the procurement information database 306 so that the order may be filled (operation 464). In addition, the purchaser may provide procurement information retrieved from the procurement information database 306 to the purchaser via the e-mail interface 302 (operation 464). In one embodiment, this information may constitute an acknowledgement of the purchase order, and may include a purchase order number, a customer number associated with the purchaser, a net monetary amount for the purchase order, and an estimated shipping date, as well as any other information possibly associated with the specific purchase. If, however, the requested part is not available from the supplier, an error indication may be returned (operation 468).

Once a purchase order has been placed, the purchaser may then request procurement information regarding the status of the purchase order (operations 410, 480 for FIG. 4A, and FIG. 4E). To identify the particular purchase involved, the procurement information request may include the purchase order number, possibly in addition to the customer number of the purchaser (operation 482). In return, the procurement information processor 304 may retrieve the procurement information from the database 306 relating to the current status of the indicated purchase order (operation 484). This information may include, but is not limited to, an internal order number identifying the particular purchase order to the supplier, a point-of-sale (POS) number, an item code indicating the particular items being purchased, a quantity of the item that has been ordered, a quantity of the item that has already been shipped, a quantity that is on backorder, a scheduled ship date, an actual ship date, and a net monetary amount. Also, any pending product delivery commitments may be summarized within the purchase order status information. In the case the status request does not indicate a valid purchase order number, an error indicating this fact may be returned (operation 486).

In addition, once one or more items have been shipped, a tracking number provided by a shipping carrier may be provided so that the purchaser may track a particular shipment associated with the purchase order. Typically, the tracking number may be implemented as a clickable link within the e-mail message that provides additional purchase order status information. For example, this link may open a web browser that couples the user with a webpage provided by the carrier that indicates the current status of the shipment.

Several advantages may be realized by use of various embodiments of the present invention. For example, as the system provides an automated means for obtaining information related to the procurement of parts or items available from a supplier, direct communication with a human customer service representative of the supplier by way of telephone or e-mail, with its inherent time delays, is avoided. Also, unlike most websites providing ordering and order status information, the use of e-mail typically provides a simplified, plain-text format easily interfaced with by PDAs, mobile phones, and other small communication devices. Further, an e-mail-based system allows a purchaser to submit a procurement information request while the procurement information system is currently unavailable, as the requests will likely be queued by an e-mail interface until they can be processed. Websites that are unavailable, however, typically prevent submission of such requests.

While several embodiments of the invention have been discussed herein, other embodiments encompassed within the scope of the invention are possible. For example, while the examples provided above refer to purchasers and suppliers, other participants within the economy, such as retailers, distributors, end-users, and the like, may benefit from the use of the embodiments discussed above. Also, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A procurement information system, comprising:
a database configured to store information;
an electronic mail interface configured to receive a first information request over a communication link, and to transfer over the communication link first retrieved information relating to the first information request; and
a processor configured to process the first information request to determine the first retrieved information, and to retrieve the first retrieved information from the database;
wherein the first information request comprises a price quote request for a first item unavailable for shipment at the time the first information request is received, and
wherein the first retrieved information comprises a price quote for a second item available for shipment at the time the first information request is received.

2. The procurement information system of claim 1, wherein a first electronic mail message comprises the first information request in plain-text format.

3. The procurement information system of claim 1, wherein a second electronic mail message comprises the first retrieved information in plain-text format, rich-text format, or hypertext transfer protocol.

4. The procurement information system of claim 1, wherein:
the electronic mail interface is further configured to receive a second information request over the communication link, and to transfer over the communication link second retrieved information relating to the second information request; and
wherein the processor is configured to process the second information request to determine the second retrieved information, and to retrieve the second retrieved information from the database.

5. The procurement information system of claim 4, wherein the processor is further configured to recognize within the second information request a partial part number for a third item.

6. The procurement information system of claim 4, wherein the second information request comprises a product information request for a third item.

7. The procurement information system of claim 6, wherein the second retrieved information comprises at least one of a photograph, computer-aided design information, a product data sheet, and a product review for the third item.

8. The procurement information system of claim 6, wherein the second retrieved information comprises at least one of a photograph, computer-aided design information, a product data sheet, and a product review for a substitute of the third item.

9. The procurement information system of claim 4, wherein the second information request comprises a product information request for an item category.

10. The procurement information system of claim 9, wherein the second retrieved information comprises a list of item numbers associated with the item category.

11. The procurement information system of claim 4, wherein the second information request comprises a price quote request for a third item.

12. The procurement information system of claim 11, wherein the second retrieved information comprises at least one of a part number, a brief description, a list price, a net price, a quantity in stock, a lead time, a time and date stamp, and an expiration date for the third item.

13. The procurement information system of claim 11, wherein the second retrieved information comprises at least one of a part number, a brief description, a list price, a net price, a quantity in stock, a lead time, a time and date stamp, and an expiration date for a substitute of the third item.

14. The procurement information system of claim 13, wherein the substitute of the third item is in stock.

15. The procurement information system of claim 4, wherein the second information request comprises a purchase order for a third item.

16. The procurement information system of claim 15, wherein the processor is further configured to place the purchase order in the database.

17. The procurement information system of claim 15, wherein the second retrieved information comprises an acknowledgement of the purchase order, the acknowledgement comprising at least one of a purchase order number, a customer number, a net monetary amount, and a shipping date for the third item.

18. The procurement information system of claim 4, wherein the second information request comprises a status request for a purchase order for a third item.

19. The procurement information system of claim 18, wherein the second retrieved information comprises an internal order number, a point-of-sale number, an item code for the third item, a purchased quantity of the third item, a shipped quantity of the third item, a backordered quantity of the third item, a scheduled ship date, an actual ship date, a net monetary amount, and a shipment tracking number.

20. The procurement information system of claim 19, wherein the shipment tracking number comprises a link to a webpage of a carrier.

21. A method of providing procurement information, comprising:
receiving over a communication link a first electronic mail message comprising a first information request;
processing the first information request to determine first retrieved information;
retrieving the first retrieved information from a database; and
transferring over the communication link a second electronic mail message comprising the first retrieved information;
wherein the first information request comprises a price quote request for a first item unavailable for shipment when the first information request is received, and
wherein the first retrieved information comprises a price quote for a second item available for shipment when the first information request is received.

22. The method of claim 21, wherein first information request is presented in plain-text format in the first electronic mail message.

23. The method of claim 21, wherein the first retrieved information is presented in plain-text format, rich-text format, or hypertext transfer protocol in the second electronic mail message.

24. The method of claim 21, further comprising:
receiving over the communication link a third electronic mail message comprising a second information request;
processing the second information request to determine second retrieved information;
retrieving the second retrieved information from the database; and
transferring over the communication link a fourth electronic mail message comprising the second retrieved information.

25. The method of claim 24, wherein processing the second information request comprises recognizing a partial part number for a third item.

26. The method of claim 24, wherein the second information request comprises a product information request for a third item.

27. The method of claim 26, wherein the second retrieved information comprises at least one of a photograph, computer-aided design information, a product data sheet and a product review for the third item.

28. The method of claim 26, wherein the second retrieved information comprises at least one of a photograph, computer-aided design information, a product data sheet, and a product review for a substitute of the third item.

29. The method of claim 24, wherein the second information request comprises a product information request for an item category.

30. The method of claim 29, wherein the second retrieved information comprises a list of item numbers associated with the item category.

31. The method of claim 24, wherein the second information request comprises a price quote request for a third item.

32. The method of claim 31, wherein the second retrieved information comprises at least one of a part number, a brief description, a list price, a net price, a quantity in stock, a lead time, a time and date stamp, and an expiration date for the third item.

33. The method of claim 31, wherein the second retrieved information comprises at least one of a part number, a brief description, a list price, a net price, a quantity in stock, a lead time, a time and date stamp, and an expiration date for a substitute of the third item.

34. The method of claim 33, wherein the substitute of the third item is in stock.

35. The method of claim 24, wherein the second information request comprises a purchase order for a third item.

36. The method of claim 35, further comprising placing the purchase order in the database.

37. The method of claim 35, wherein the second retrieved information comprises an acknowledgement of the purchase order, the acknowledgement comprising at least one of a purchase order number, a customer number, a net monetary amount, and a shipping date for the third item.

38. The method of claim 24, wherein the second information request comprises a status request for a purchase order for a third item.

39. The method of claim 38, wherein the second retrieved information comprises an internal order number, a point-of-sale number, an item code for the third item, a purchased quantity of the third item, a shipped quantity of the third item, a backordered quantity of the third item, a scheduled ship date, an actual ship date, a net monetary amount, and a shipment tracking number.

40. The method of claim 39, wherein the shipment tracking number comprises a link to a webpage of a carrier.

41. A procurement information system, comprising:
means for storing information;
means for receiving an information request over a communication link;
means for processing the information request to determine retrieved information;
means for retrieving the retrieved information from a database; and
means for transferring over the communication link the retrieved information;
wherein the information request comprises a request for a price quote for a first item unavailable for shipment at the time the information request is received, and
wherein the retrieved information comprises a price quote for a second item available for shipment at the time the information request is received.
